(19) United States
(12) Patent Application Publication
(10) Pub. No.: US 2017/0225732 A1
(43) Pub. Date: Aug. 10, 2017

(54) BICYCLE SEAT ADJUSTMENT DEVICE

(71) Applicant: KIND SHOCK HI-TECH CO., LTD., Tainan City 709t (TW)

(72) Inventor: JUNG YU HSU, TAINAN CITY 709 (TW)

(21) Appl. No.: 15/015,594

(22) Filed: Feb. 4, 2016

(51) Int. Cl. B62J 1/08; B62J 1/04

(52) U.S. Cl. CPC B62J 1/08; B62J 1/04

(57) ABSTRACT

A bicycle seat adjustment device includes a seat tube and a seat post inserted in the seat tube. A base is connected to the top of the seat post. A control unit has an adjustment device located between the seat tube and the seat post to control movement of the seat post. A pivotal unit has a pivotal member, a link and a collar. The pivotal member is pivotally connected between the base and the link. The collar is mounted to the seat post and pivotally connected to the link. A connection unit is pivotably connected to the pivotal member and connected with a seat. When adjusting the seat, the seat is able to be pivoted by cooperation from the pivotal unit simultaneously.

### BACKGROUND OF THE INVENTION

1. Fields of the Invention

The present invention relates to a bicycle seat adjustment device, and more particularly, to a bicycle seat adjustment device which allows the user to adjust the height, the inclination and horizontal movement of the seat.

2. Descriptions of Related Art

The conventional bicycle seat adjustment devices usually utilize a pneumatic cylinder, a hydraulic cylinder, a spring or a mechanical adjustment device to adjust the height of the seat according to the needs of individual users.

The seat post is movably inserted into the seat tube, and the seat is connected to the top of the seat post. The conventional adjustment devices can be cataloged into two types. The first type includes a seat tube with a connection portion on the top thereof. The connection portion has a slot and an annular cap. Each of the two sidewalls of the slot has two pivotal holes. A spring unit is located at a lower portion of the seat tube and has an end member connected to the lower end of the seat tube. A spring has its lower end contacting against the end member. The seat post is irritably inserted in the seat tube, and the lower end of the seat post contacts the spring unit. Multiple teeth are formed at the seat post and located corresponding to the slot. An engaging unit is located in the slot and has two engaging members, two pins and at least one torsion spring, wherein the pins extend through the engaging members and the pivotal holes so that the engaging members are pivotably connected to the slot. Each engaging member has a pawl and an arm extending from the pawl. The pawls of the two engaging members extend through the slot and are engaged with the teeth of the seat post. The engaging member that is located at a higher position has a cable connection portion, and the arm of the higher engaging member presses on the arm of the lower engaging member. The at least one torsion spring is mounted to the pin at the lower position and applies the resilient force to the arm of the lower engaging member so that the two engaging members are activated together.

The engagement of the pawls of the engaging members and the teeth of the seat post is controlled by a cabled control device, when the pawls of the engaging members are not engaged with the teeth of the seat post, the seat post can be adjusted, vice versa. Nevertheless, the inclination of the seat cannot be simultaneously adjusted when adjusting the height of the seat. This adjustment of inclination is required when the bicycle is ridden along a slope. If the inclination of the seat is not properly adjusted, the weight center of the rider cannot be maintained in a stable status.

The second type includes a control device that is connected to the lower end of the seat tube so as to control the plunge in the seat tube to move upward so as to adjust the height of the seat. The control device includes a body which is fixed to the lower end of the seat tube, and a link unit which has a lower link and a higher link. Each of the lower link and the higher link has its middle portion pivotably connected to the body eccentrically. One of the lower link and the higher link has a pin connected thereto, and the other one has a slot that is wider than the diameter of the pin. The pin extends through the slot so that the lower link and the higher link are pivotably connected to each other. The lower link is connected with a cabled control device at a control end thereof, and the higher link has a push end on the top thereof and the push end is located beneath the plunge. When the push end is pulled downward by the cabled control device, the push end pushes the plunge to move upward so as to adjust the height of the seat.

Again, the inclination of the seat cannot be simultaneously adjusted when adjusting the height of the seat, and the same shortcomings exist as the first type.

The present invention intends to provide a bicycle seat adjustment device to eliminate the shortcomings mentioned above.

### SUMMARY OF THE INVENTION

The present invention relates to a bicycle seat adjustment device and comprises a seat tube and a seat post inserted in the seat tube. A base is connected to the top of the seat post. A control unit has an adjustment device located between the seat tube and the seat post to control movement of the seat post. A pivotal unit has a pivotal member, a link and a collar. The pivotal member is pivotally connected between the base and the link. The collar is mounted to the seat post and pivotally connected to the link. A connection unit is pivotably connected to the pivotal member and connected with a seat. When adjusting the seat, the seat is able to be pivoted by cooperation from the pivotal unit simultaneously. A positioning member extends through an aperture defined in the collar and has a bead which is resiliently biased. The seat post has a positioning portion on the outside thereof. When the collar is moved downward to a pre-set position, the bead is engaged with the positioning portion to prevent the collar from continuously sliding downward. When the seat post is lowered, the collar is pushed by the seat tube, the bead is disengaged from the positioning portion to release the positioning status. There is a resilient member located between the collar and the base to provide the collar a resilient force to move back to its original position. There is a biasing member located between the extension of the collar and the link to enhance the feature of returning back of the collar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle seat adjustment device of the present invention;

FIG. 2 is a side view to show the bicycle seat adjustment device of the present invention;

FIG. 3 is an exploded view of the bicycle seat adjustment device of the present invention;

FIGS. 4 to 6 show three different adjustments of the seat by the bicycle seat adjustment device of the present invention;

FIG. 7 is a perspective view to show the second embodiment of the bicycle seat adjustment device of the present invention;

FIG. 8 is an exploded view of the bicycle seat adjustment device of the present invention disclosed in FIG. 7;

FIG. 9 is a side view of the bicycle seat adjustment device of the present invention disclosed in FIG. 7, and

FIGS. 10 and 11 show two different adjustments of the seat by the bicycle seat adjustment device of the present invention disclosed in FIG. 7.

### DETAILED DESCRIPTION OF THE PREFERRED EMBODIMENT

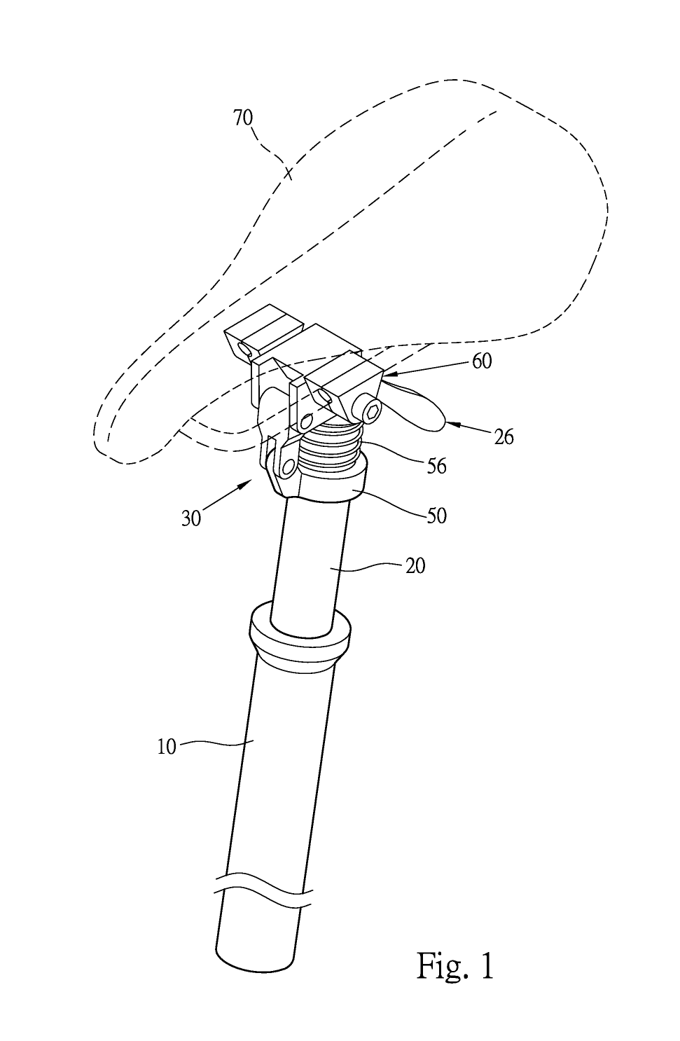

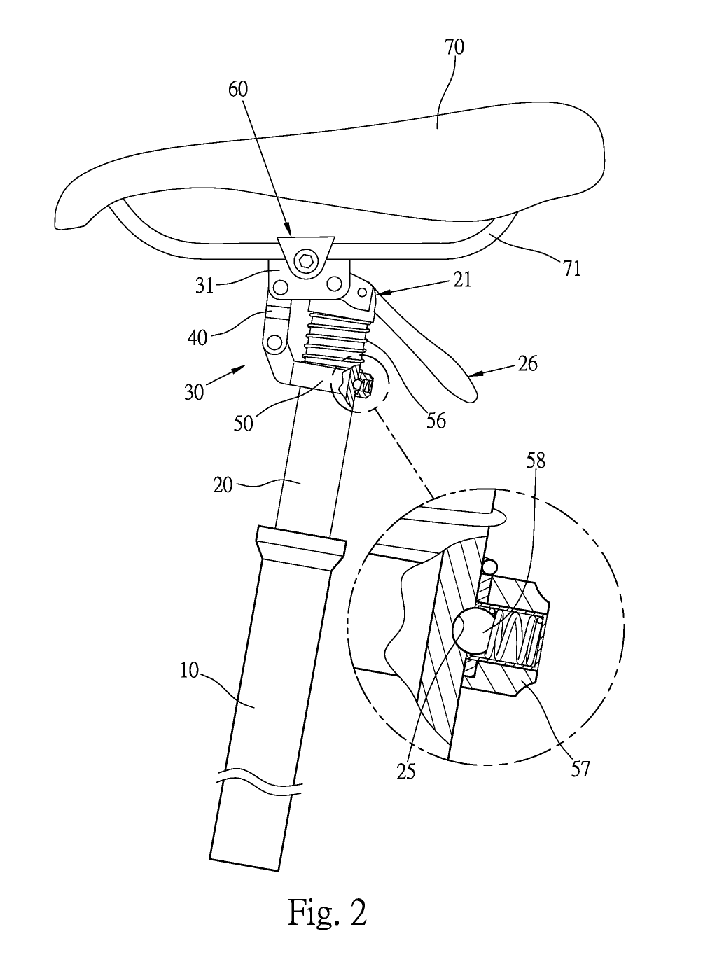

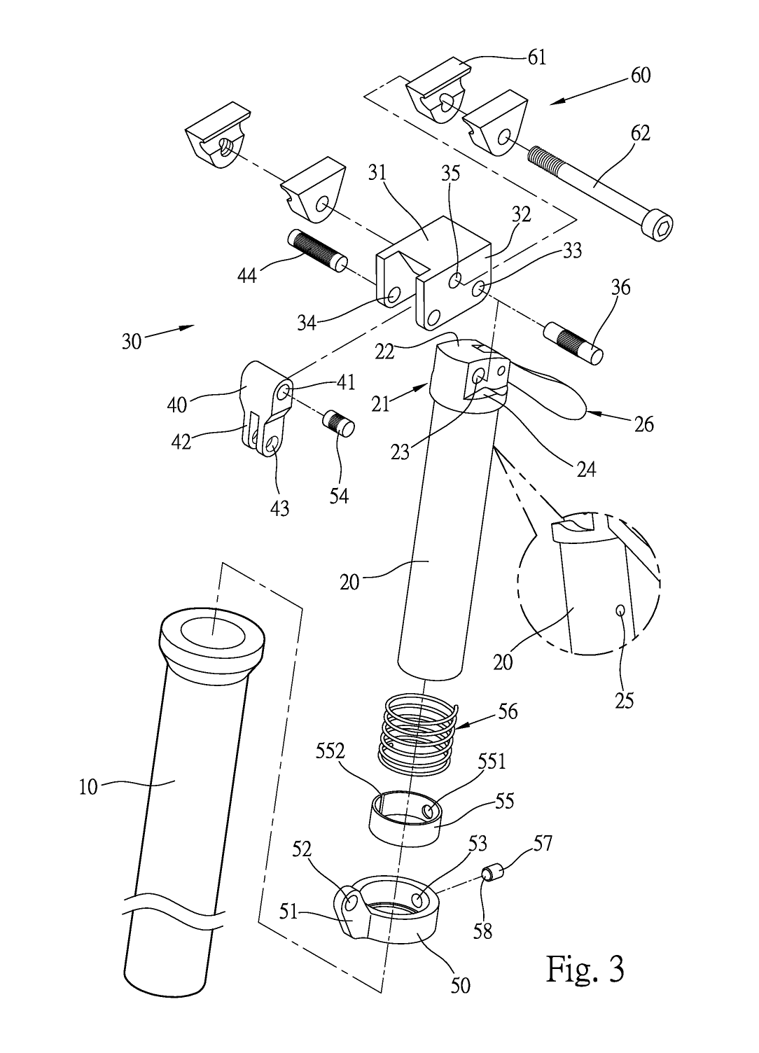

Referring to FIGS. 1 to 6, the bicycle seat adjustment device of the present invention comprises a seat tube 10, a seat post 20, a pivotal unit 30, a control device 26 and a connection unit 60.

The seat post 20 has a lower end thereof movably inserted in the seat tube 10. A base 21 is connected to the top of the seat post 20. The base 21 is a cylindrical base and has a pivotal portion 22 extending from the top thereof. A stepped portion is formed between the pivotal portion 22 and the base 21. The pivotal portion 22 has a pivotal hole 23 defined therethrough. Two curved support faces 24 are formed on the base 21 and the pivotal portion 22 is located between the two support faces 24 which are located close to the pivotal hole 23. the seat post 20 has a positioning portion 25 on an outside thereof, and the positioning portion 25 has a semi-circular recess.

The control unit 26 has an adjustment device located between the seat tube 10 and the seat post 20 so as to control movement of the seat post 20.

The pivotal unit 30 has a pivotal member 31, a link 40, a collar 50, and a resilient member 56. The pivotal member 31 is a U-shaped member and has two side panels 32. Each side panel 32 has a first hole 33, a second hole 34 and a third hole 35 which is located at the central portion of the side panel 32 corresponding thereto. The third hole 35 is located higher than the first and second holes 33, 34. The pivotal member 31 is pivotally connected to the base 21 and the pivotal portion 22 is located between the two side panels 32. A first pin 36 extends through the first holes 33 of the two side panels 32 and the pivotal hole 23.

The link 40 has a first passage 41 and two lugs 42 extend from the link 41. Each lug 42 has a second passage 43. The link 40 is located between the two side panels 32. A second pin 44 extends through the first passage 41 and the second holes 34.

The collar 50 is mounted to the seat post 20 and has an extension 51 extending radially from the outside thereof. The extension 51 has a connection hole 52. The extension 51 is located between the two lugs 42. An aperture 53 is defined in the collar 50 and located diametrically from the extension 51. A third pin 54 extends through the connection hole 52 and the second passage 43. The pivotal member 31, the link 40 and the collar 50 form a link mechanism. A C-shaped member 55 is located in the collar 50 and has a through hole 551. A gap 552 is defined between two distal ends of the C-shaped member 55. The resilient member 56 is a spring. The collar 50 and the resilient member 56 are mounted to the seat post 20. The resilient member 56 is biased between the underside of the base 21 and the top of the collar 50. A positioning member 57 extends through the aperture 53 and has a bead 58 which is resiliently biased. The bead 58 protrudes from the positioning member 57, the aperture 53 and the through hole 551, and is engaged with the positioning portion 25.

The connection unit 60 is located at the top of the seat post 20 and has multiple clamp members 61 which clamp the rails 71 of a seat 70. A bolt 62 extends through the clamp members 61 and the third hole 35 of the pivotal member 31, and is cooperated with the control device 26 to adjust the movement of the seat post 20 so that the height of the seat 70 is adjusted.

When operating the control device 26 to lower the seat 70, the pivotal unit 30 is lowered, the top of the seat tube 10 pushes the collar 50, and the bead 58 is moved toward the positioning member 57 to be disengaged from the positioning portion 25. The positioned status is released. The base 21 together with the seat post 20 are lowered and compresses the resilient member 56. The link 40 is activated so that the pivotal member 31 is pivoted along with the lowering of the base 21. The seat 70 is then pivoted to tilt backward such that the weight center of the rider moves backward when riding along a down slope road. On the contrary, when the operating the control device 26 to lift the seat 70, the collar 50 is separated from the seat tube 10, the resilient member 56 bounces back to push the collar 50 downward, and also drives the link 40, the pivotal member 31 is then pivoted. The seat 70 is pivoted forward and back to its original position.

When operating the control device 26 to adjust the seat 70, the pivotal unit is activated to pivot the seat 70 to adjust the inclination of the seat 70 to cooperate with the change of the weight center of the rider.

When assembling, the pivotal member 31 is pivotably connected to the base 21, and the clamp members 61 of the connection unit 60 clamp the rails 71 of the seat 70. The clamp members 61 are pivotably connected to the pivotal member 31 to which the link 40 is pivotably connected. The collar 50 and the resilient member 56 are mounted to the seat post 20. The seat post 20 is inserted into the seat tube 10. The control device 26 is located between the seat tube 10 and the seat post 20. The extension 51 of the collar 50 is then pivotably connected to the lugs 42 of the link 40.

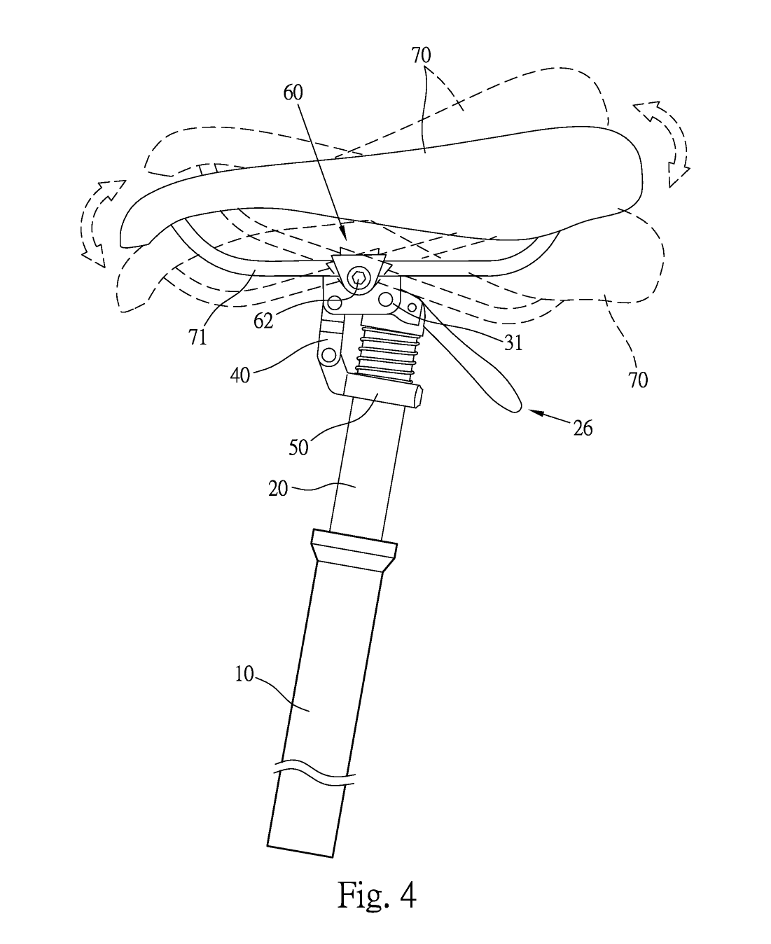

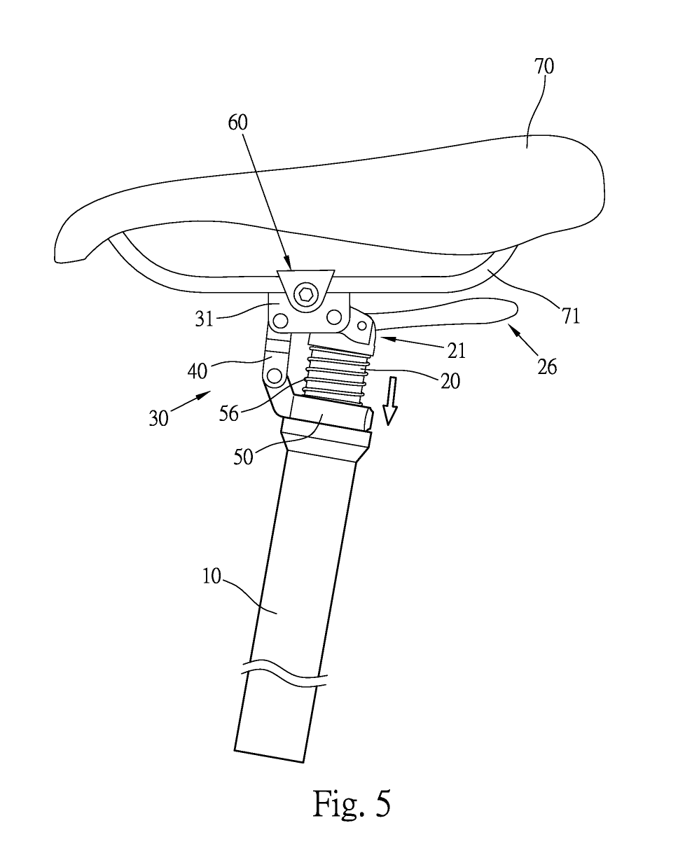

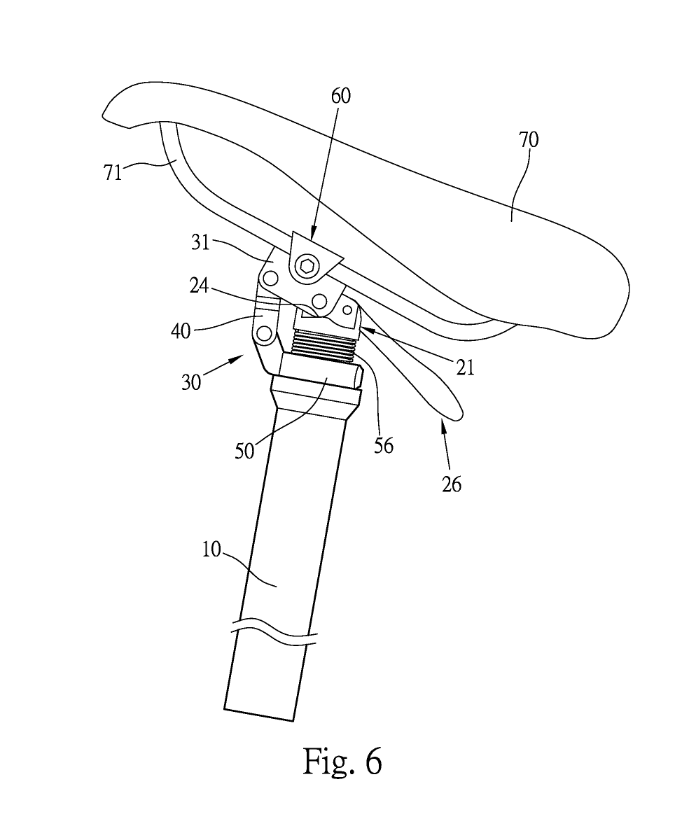

As shown in FIG. 4, the inclination of the seat 70 is first adjusted, and the bolt 62 is used to set the seat 70. As shown in FIGS. 5 and 6, when operating the control device 26 to lower the seat 70, the pivotal unit 30 is lowered, the top of the seat tube 10 pushes the collar 50, and the bead 58 is moved toward the positioning member 57 to be disengaged from the positioning portion 25. The positioned status is released. The base 21 together with the seat post 20 are lowered and compresses the resilient member 56. The link 40 is activated so that the pivotal member 31 is pivoted along with the lowering of the base 21. The seat 70 is then pivoted to tilt backward such that the weight center of the rider moves backward when riding along a down slope road. On the contrary, when the operating the control device 26 to lift the seat 70, the collar 50 is separated from the seat tube 10, the resilient member 56 bounces back to push the collar 50 downward, and also drives the link 40, the pivotal member 31 is then pivoted. The seat 70 is pivoted forward and back to its original position. The bead 58 is protruded and is engaged with the positioning portion 25 to stop the pivotal unit 30.

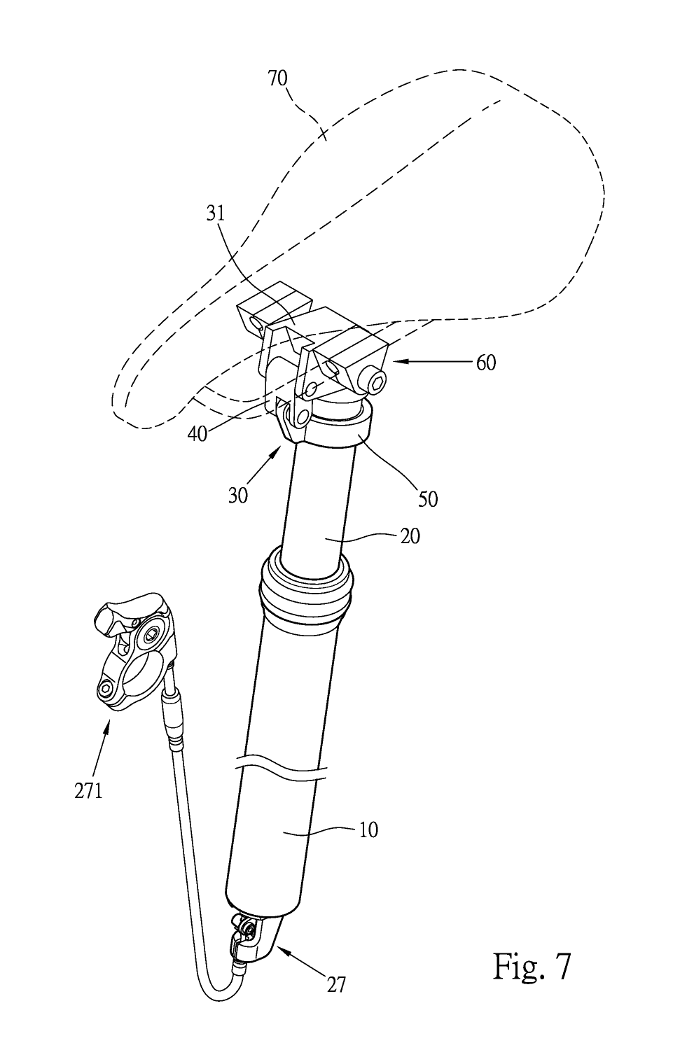

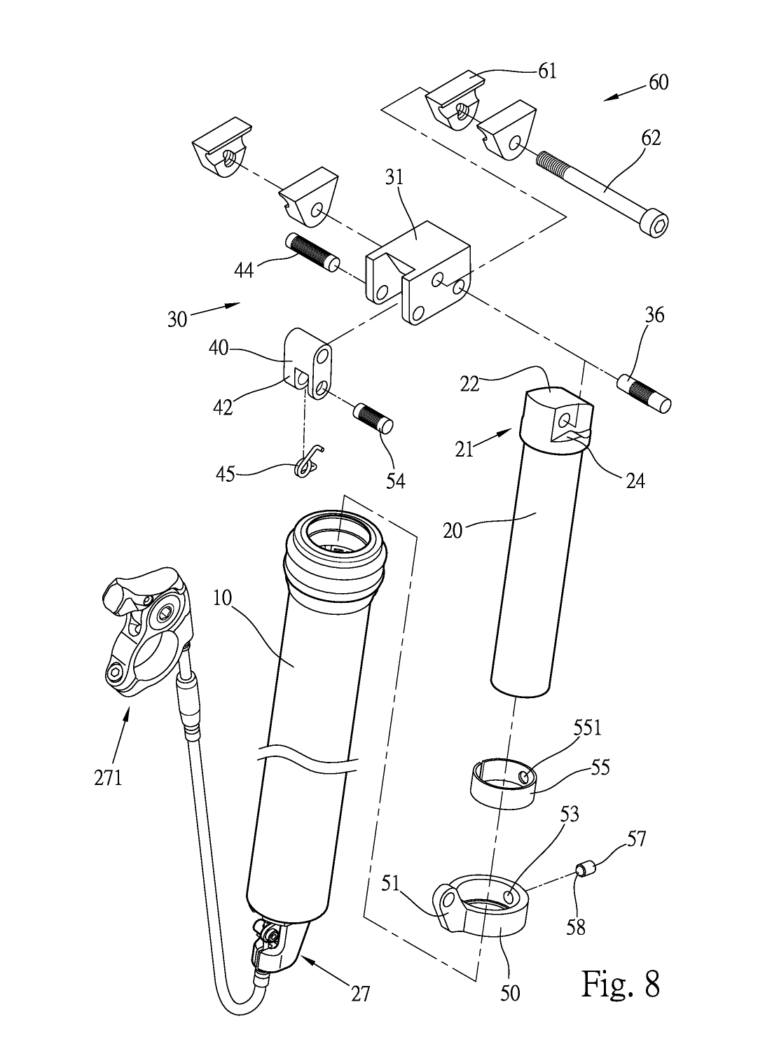

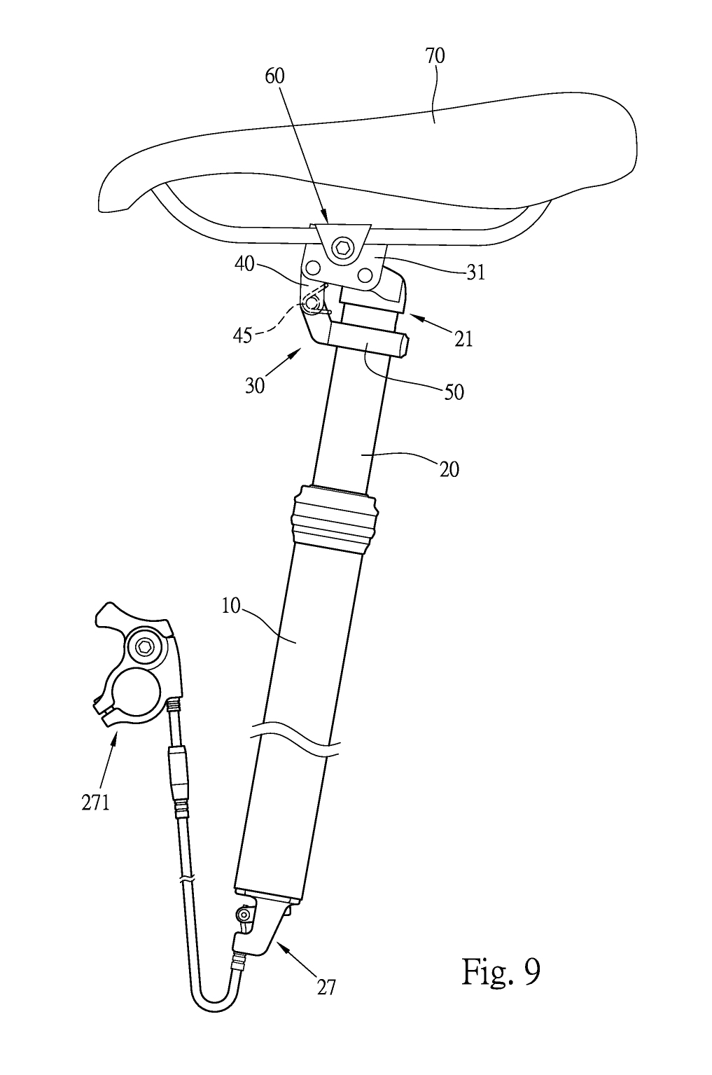

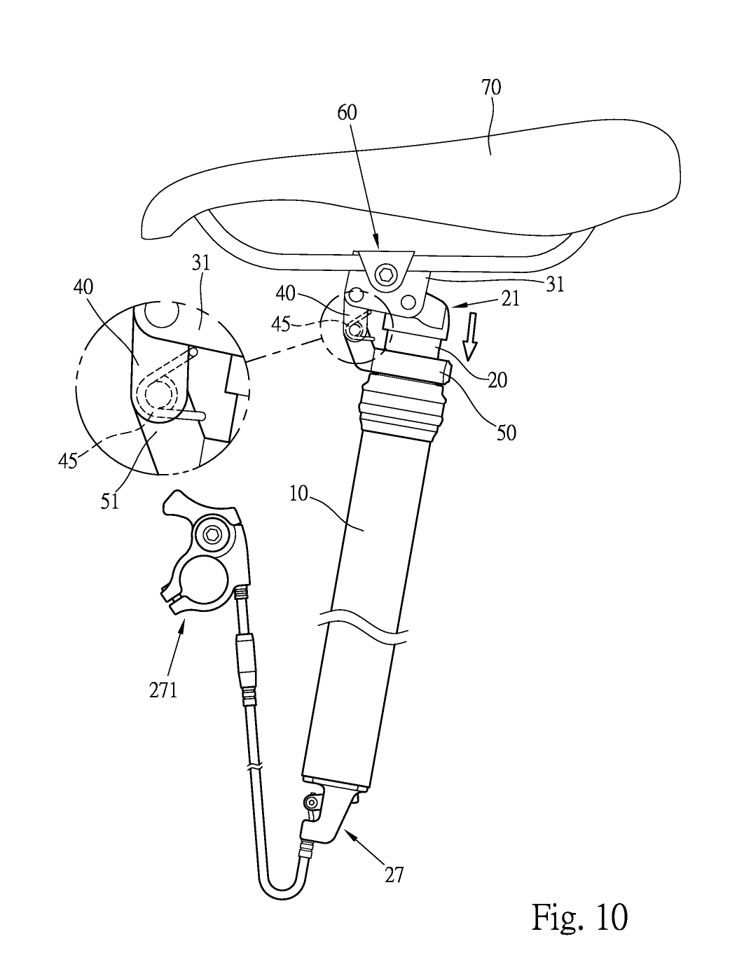

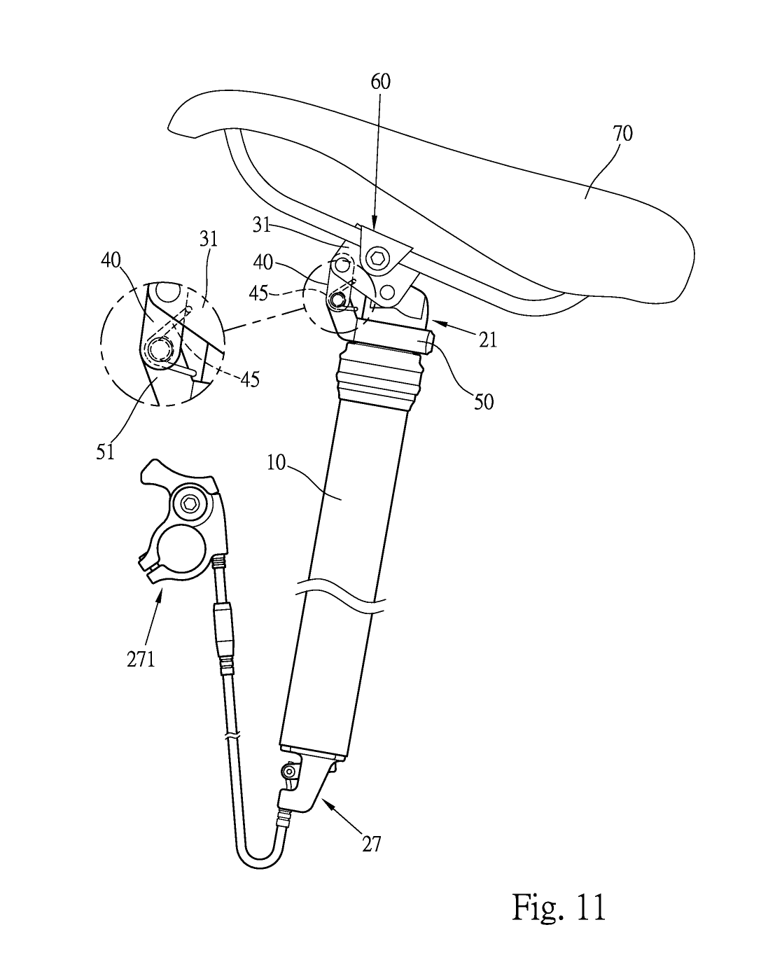

FIGS. 7 to 11 show another embodiment of the present invention, wherein the control device 27 is located at the lower portion of the seat tube 10, and has a cabled control unit 271 which drives the seat post 20 to move relative to the seat tube 10. A biasing member 45 is located between the link 40 and the extension 51 of the collar 50. The biasing member 45 is a torsion spring. The third pin 54 extends through the extension 51, the biasing member 45 and the lugs 42. The biasing member 45 is biased between the link 40 and the extension 51 to help the collar 50 to move back to its original position.

The present invention allows the rider to operate the control device 26 or 27 to adjust the seat post 20 relative to the seat tube 10. The pivotal unit 30 is connected to the base 21 and connected to the link 40 and the collar 50. The seat 70 can be lowered and the pivotal unit 30 pushes the front end of the seat 70 upward to pivot the pivotal member 31 so that the rear end of the seat 70 is lowered. By this adjustment, when the rider rides the bicycle along a down slope road, the weight center of the rider is moved backward so that the rider's thighs and hip do not hit the seat 70. When the seat 70 is lifted, the inclination of the seat 70 is simultaneously adjusted.

The collar 50 further has the positioning member 57 which has the bead 58 which is engaged with the positioning portion 25 of the seat post 20 to prevent the collar 50 from continuously moved downward. When the seat post 20 is lowered, the collar 50 is pushed by the seat tube 10 to disengage the bead 58 from the positioning portion 25 to release the positioned status.

The resilient member 56 between the collar 50 and the base 21 assists the collar 50 to move back to its original position. Alternatively, the biasing member 45 is located between the link 40 and the extension 51 of the collar 50 to help the movement of the collar 50.

While we have shown and described the embodiment in accordance with the present invention, it should be clear to those skilled in the art that further embodiments may be made without departing from the scope of the present invention.

What is claimed is:

1. A bicycle seat adjustment device comprising:
a seat tube;
a seat post having a lower end inserted in the seat tube, a base connected to a top of the seat post;
a control unit having an adjustment device located between the seat tube and the seat post so as to control movement of the seat post;
a pivotal unit having a pivotal member, a link, and a collar, the pivotal member being pivotally connected between the base and the link, the collar mounted to the seat post and pivotally connected to the link, and
a connection unit pivotably connected to the pivotal member and adapted to be connected with a seat.

2. The bicycle seat adjustment device as claimed in claim 1, wherein the base is a cylindrical base and has a pivotal portion extending from a top thereof, a stepped portion is formed between the pivotal portion and the base.

3. The bicycle seat adjustment device as claimed in claim 1, wherein the base is a cylindrical base, the collar and a resilient member are mounted to the seat post, the resilient member is biased between an underside of the base and a top of the collar.

4. The bicycle seat adjustment device as claimed in claim 1, wherein the pivotal member has two side panels, the base is a cylindrical base and has a pivotal portion extending from a top thereof, the pivotal member is mounted onto the base, the pivotal portion is located between the two side panels, a first pin extends through the pivotal member, the side panels and the pivotal portion, the link has two lugs, the link is located between the two side panels of the pivotal member, a second pin extends through the side panels and the link, the collar is mounted to the seat post and has an extension extending radially from an outside thereof, the extension is located between the two lugs of the link, a third pin extends through the lugs and the extension.

5. The bicycle seat adjustment device as claimed in claim 1, wherein the pivotal member has two side panels, each side panel has a first hole, a second hole and a third hole which is located higher than the first and second holes, the base is a cylindrical base and has a pivotal portion extending from a top thereof, the pivotal portion has a pivotal hole defined therethrough, the pivotal member is mounted to the base and the pivotal portion is located between the two side panels of the pivotal member, a first pin extends through the first holes of the two side panels and the pivotal hole, the link has a first passage and two lugs extend from the link, each lug has a second passage, the link is located between the two side panels, a second pin extends through the first passage and the second holes, the collar is mounted to the seat post and has an extension extending radially from an outside thereof, the extension has a connection hole, the extension is located between the two lugs, a third pin extends through the connection hole and the second passage.

6. The bicycle seat adjustment device as claimed in claim 1, wherein the pivotal member has two side panels, each side panel has a first hole, a second hole and a third hole which is located at a central portion of the side panel corresponding thereto, the third hole is located higher than the first and second holes, the base is a cylindrical base and has a pivotal portion extending from a top thereof, a stepped portion is formed between the pivotal portion and the base, the pivotal portion has a pivotal hole defined therethrough, two curved support faces are formed on the base and the pivotal portion is located between the two support faces which are located close to the pivotal hole, the pivotal member is mounted to the base and the pivotal portion is located between the two side panels of the pivotal member, a first pin extends through the first holes of the two side panels and the pivotal hole, the link has a first passage and two lugs extend from the link, each lug has a second passage, the link is located between the two side panels, a second pin extends through the first passage and the second holes, the collar is mounted to the seat post and has an extension, the extension has a connection hole extending radially from an outside thereof, the extension is located between the two lugs, a third pin extends through the connection hole and the second passage.

7. The bicycle seat adjustment device as claimed in claim 1, wherein the collar is mounted to the seat post and has an extension extending radially from an outside thereof, the extension has a connection hole, the extension is pivotably connected to the link, an aperture is defined in the collar and located diametrically from the extension, a positioning member extends through the aperture, the seat post has a positioning portion on an outside thereof, the positioning member is engaged with the positioning portion.

8. The bicycle seat adjustment device as claimed in claim 1, wherein the collar is mounted to the seat post and has an extension extending radially from an outside thereof, the extension has a connection hole, the extension is pivotably connected to the link, an aperture is defined in the collar and located diametrically from the extension, a positioning member extends through the aperture and has a bead which is resiliently biased, the seat post has a positioning portion on an outside thereof, the positioning portion has a semi-circular recess, the bead protrudes from the positioning member and the aperture, and is engaged with the recess of the positioning portion.

9. The bicycle seat adjustment device as claimed in claim 1, wherein the collar is mounted to the seat post and has an extension extending radially from an outside thereof, the extension is pivotably connected to the link, an aperture is defined in the collar and located diametrically from the extension, a C-shaped member is located in the collar and has a through hole, a positioning member extends through the aperture and has a bead which is resiliently biased, the seat post has a positioning portion on an outside thereof, the positioning portion has a semi-circular recess, the bead protrudes from the positioning member, the aperture and the through hole, and is engaged with the positioning portion.

10. The bicycle seat adjustment device as claimed in claim 1, wherein the base is a cylindrical base, the collar is mounted to the seat post and has an extension extending radially from an outside thereof, a biasing member is located between the link and the extension of the collar.
